(19) United States
(12) Patent Application Publication
(10) Pub. No.: US 2025/0251600 A1
(43) Pub. Date: Aug. 7, 2025

(54) NEAR-EYE DISPLAY DEVICE

(71) Applicants: Asphetek Solution (Chengdu) Ltd., Chengdu (CN); ADVANCED OPTOELECTRONIC TECHNOLOGY, INC., Hsinchu County (TW); Asphetek Solution Inc., Hsinchu (TW)

(72) Inventors: YUAN-TING LIANG, Hsinchu (TW); YING-HUNG TSAI, Hsinchu (TW)

(21) Appl. No.: 18/749,759

(22) Filed: Jun. 21, 2024

(30) Foreign Application Priority Data
Feb. 6, 2024 (CN) 202420284562.2

(51) Int. Cl. G02B 27/01

(52) U.S. Cl. CPC G02B 27/0172; G02B 2027/0178

(57) ABSTRACT

The present application provides a near-eye display device. The near-eye display device includes an optical waveguide, a display, an optical splitter assembly, a first coupling-out member and a second coupling-out member. The optical waveguide defines a first surface and a second surface; the first surface defines a first emergent area and a second emergent area. The display is located on the optical waveguide. The optical splitter assembly is configured to split the first image light into a first light beam and a second light beam. The first light beam propagates within the optical waveguide to the first coupling-out member, and the first coupling-out member is configured to couple the first light beam out of the optical waveguide. The second light beam propagates within the optical waveguide to the second coupling-out member, and the second coupling-out member is configured to couple the second light beam out of the optical waveguide.

### FIELD

The present application relates to a field of display technology, and specifically to a near-eye display device.

### BACKGROUND

Near-eye display devices for Augmented Reality (AR) technology are used widely. AR technology use display as image source, and the display projects an image into human eyes for imaging through optical components.

Some existing near-eye display devices, such as AR glasses or MR glasses, have a large size, resulting in a poor wearing experience for the user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding portions throughout the several views.

FIG. 1 is a diagrammatic view of a near-eye display device according to an embodiment of the present disclosure.

FIG. 2 is a diagrammatic view of a near-eye display device according to another embodiment of the present disclosure.

FIG. 3 is a diagrammatic view of a near-eye display device according to another embodiment of the present disclosure.

FIG. 4 is a diagrammatic view of a near-eye display device according to another embodiment of the present disclosure.

FIG. 5 is a diagrammatic view of a near-eye display device according to another embodiment of the present disclosure.

FIG. 6 is a diagrammatic view of a near-eye display device according to another embodiment of the present disclosure.

FIG. 7 is a diagrammatic view of a near-eye display device according to another embodiment of the present disclosure.

FIG. 8 is a diagrammatic view of a near-eye display device according to another embodiment of the present disclosure.

### DESCRIPTION OF MAIN COMPONENTS OR ELEMENTS

near-eye display device 100;
optical waveguide 10;
first surface 11;
second surface 12;
first emergent area 13;
second emergent area 14;
incident area 15;
display 20;
optical splitter assembly 30;
optical splitter grating 31;
light absorbing portion 32;
semi-reflective portion 33;
first reflecting portion 34;
second reflecting portion 35;
third reflecting portion 36;
first coupling-out member 40;
first semi-reflective mirror 41;
first diffraction grating 42;
second coupling-out member 50;
second semi-reflective mirror 51;
second diffraction grating 52;
image light 60;
first image light 70;
first light beam 71;
second light beam 72;
second image light 80;
third beam 81;
fourth beam 82;
first wave plate 91;
second wave plate 92;
glasses frame 93;
first temple 94;
second temple 95;
first direction X;
second direction Y;
center line L.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

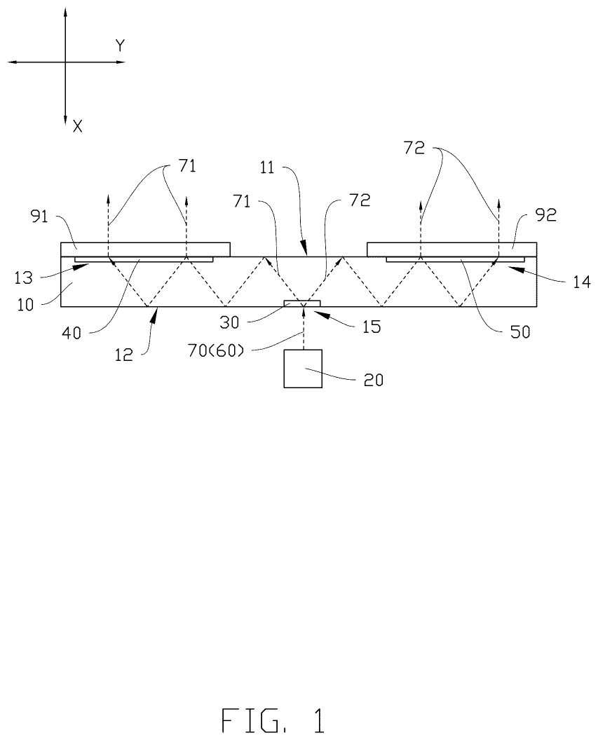

Referring to FIG. 1, in one embodiment, a near-eye display device 100 is provided, the near-eye display device 100 includes one or more optical waveguide 10, a display 20, an optical splitter assembly 30, a first coupling-out member 40 and a second coupling-out member 50. The optical waveguide 10 defines a first surface 11 and a second surface 12, the first surface 11 is close to a user of the near-eye display device 100, the second surface 12 is away from the user. The first surface 11 is opposite to the second surface 12 in a first direction X. The first surface 11 defines a first emergent area 13 and a second emergent area 14, the first emergent area 13 is spaced apart from the second emergent area 14 in a second direction Y. The first direction X intersects with the second direction Y. The first coupling-out member 40 and the second coupling-out member 50 are located on opposite sides of the optical waveguide 10 along the second direction Y. The display 20 is provided at one side of the optical waveguide 10, the display 20 is configured to emit an image light 60 into the optical waveguide 10 along the second direction Y, the image light 60 includes a first image light 70. A projection of the display 20 on the first surface 11 of the optical waveguide 10 being between the first emergent area 13 and the second emergent area 14 along the first direction X. The optical splitter assembly 30 is located on the optical waveguide 10, wherein the optical splitter assembly 30 is configured to split the first image light 70 into a first light beam 71 and a second light beam 72. The first light beam 71 propagates within the optical waveguide 10 to the first coupling-out member 40, and the first coupling-out member 40 is configured to couple the first light beam 71 out of the optical waveguide 10. The second light beam 72 propagates within the optical waveguide 10 to the second coupling-out member 50, and the second coupling-out member 50 is configured to couple the second light beam 72 out of the optical waveguide 10.

The first image light 70 is divided into the first light beam 71 and the second light beam 72 by the optical splitter assembly 30, and the first light beam 71 and the second light beam 72 are couple out from the optical waveguide 10 at intervals along the second direction Y. As a result, the near-eye display device 100 is capable of emitting the first light beam 71 and the second light beam 72 through a single display 20, the first light beam 71 and the second light beam 72 are spaced in the second direction Y, and then causing the first light beam 71 and the second light beam 72 to be projected to the user's left eye and right eye, so as to provide augmented reality content to the user.

Compared to an existing augmented reality device, number of the display 20 has decreased, and free space is increased on both sides of the optical waveguide 10 along the second direction Y, this enables other elements to be placed at free spaces? to increase the design freedom of the near-eye display device 100. Furthermore, the single display 20 has lower power consumption, lower cost, and lighter weight, so that the overall weight of the near-eye display device 100 is reduced, which can improve wearing experience of the user.

One or more optical waveguide 10 is a monolithic substrate structure in the second direction Y. The display 20 is provided between the first emergent area 13 and the second emergent area 14 of the optical waveguide 10, enables weight of the near-eye display device 100 to be symmetrical at the optical machine 20, thereby contributing to the enhancement of the wearing experience of the user.

Therefore, the near-eye display device 100 of the present embodiment has low power consumption, small size, and improved user wearing experience.

In one embodiment, the display 20 injects the image light 60 into the optical waveguide 10 along the first direction X. In other embodiment, the display 20 injects the image light 60 into the optical waveguide 10 along other direction.

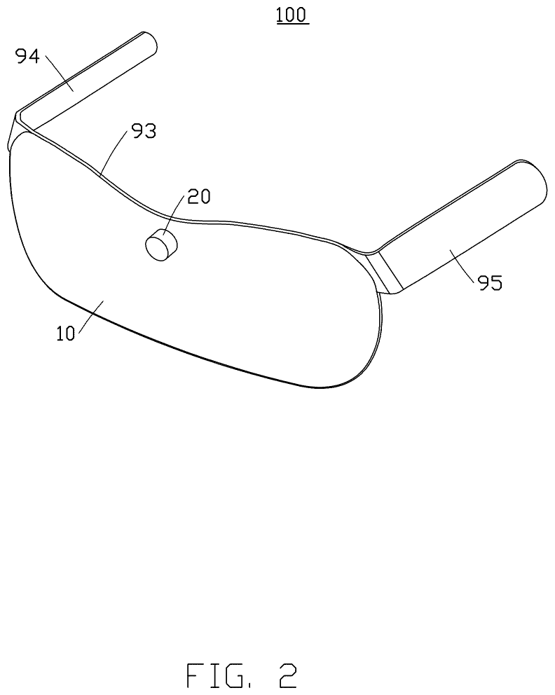

Referring to FIG. 2, in one embodiment, the near-eye display device 100 may be in a form of eyeglasses. The near-eye display device 100 further includes a glasses frame 93, a first temple 94 and a second temple 95, the first temple 94 and the second temple 95 connected to two sides of the glasses frame 93 along the second direction Y, the optical waveguide 10 and the display 20 is located on the glasses frame 93. When the near-eye display device 100 is worn by the user, the first emergent area 13 corresponds to the user's left eye, and the second emergent area 14 corresponds to the user's right eye.

In other embodiments, the near-eye display device 100 can be configured in a form of a helmet or goggles, and the near-eye display device 100 further includes a specific structure for the user to wear on the head, the optical waveguide 10 and the display 20 is located on the specific structure.

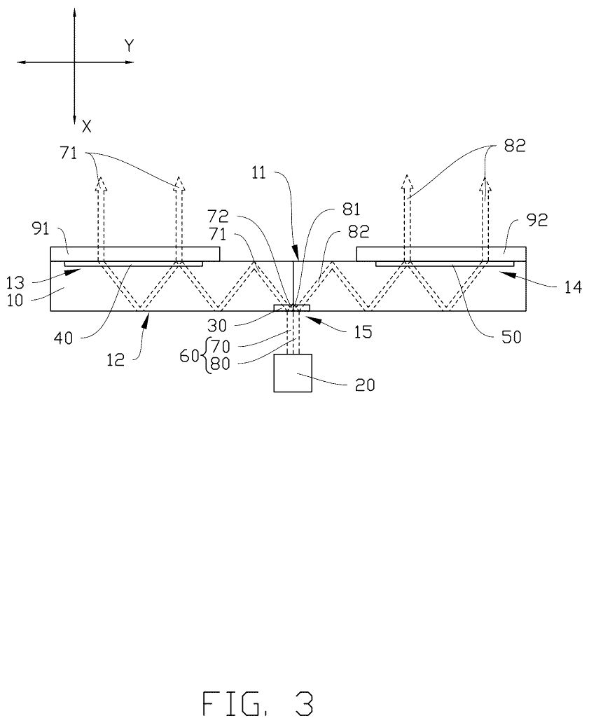

In one embodiment, referring to FIG. 3, the near-eye display device 100 further includes a first wave plate 91 and a second wave plate 92, the first wave plate 91 is arranged on the first emergent area 13, the second wave plate 92 is arranged on the second emergent area 14.

In one embodiment, the optical waveguide 10 is transparent, a real image in a real world can reach the user's eyes through the optical waveguide 10. The first light beam 71 can reach the user's left eye through the first emergent area 13, the second light beam 72 can reach the user's right eye through the second emergent area 14, and the first light beam 71 and the second light beam 72 form a virtual image. Therefore, when the user wears the near-eye display device 100, the near-eye display device 100 can superimpose the virtual image and the real image, so that the user can observe image combined with the real image and the virtual image, and achieve sensory experience beyond reality.

In one embodiment, the display 20 can be arranged on one side of the optical waveguide 10 near the user surface 11 or away from the user surface 12.

The display 20 may be any one of a Liquid Crystal On Silicon (LCOS) display, a Digital Micromirror Device (DLP) display, an micro Organic Light-Emitting Diode (OLED) display, or a micro Light-Emitting Diode (LED) display.

Light emitted from the display 20 may be visible light, and brightness of the light may ranges from 10\hat{ }3 nits to 10\hat{ }8 nits, and a volume range of the display 20 may be set from 0.1 cm\hat{ }3 to 1 cm\hat{ }3.

The display 20 may be mounted on the glasses frame 93.

Referring to FIG. 3 to FIG. 5, the optical splitter assembly 30 includes an optical splitter grating 31, the optical splitter grating 31 is configured to split the first image light 70 into a first light beam 71 and a second light beam 72. The optical splitter grating 31 coupled the first light beam 71 into the optical waveguide 10 on one side of the optical splitter grating 31 along the second direction Y. The optical splitter grating 31 coupled the second light beam 72 into the optical waveguide 10 on another side of the optical splitter grating 31 along the second direction Y.

In one embodiment, the optical splitter grating 31 is arranged inside the optical waveguide 10, and the optical splitter grating 31 is close to the first surface 11 or the second surface 12. Therefore, an optical splitting structure on the outside of the optical waveguide 10 can be omitted, and further reduce the volume of the near-eye display device 100.

In one embodiment, the optical splitter grating 31 may be provided as a diffraction grating.

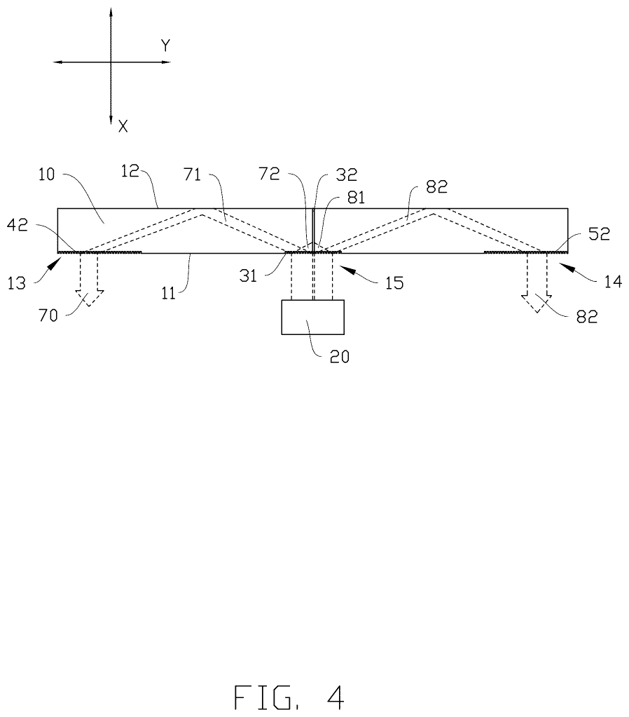

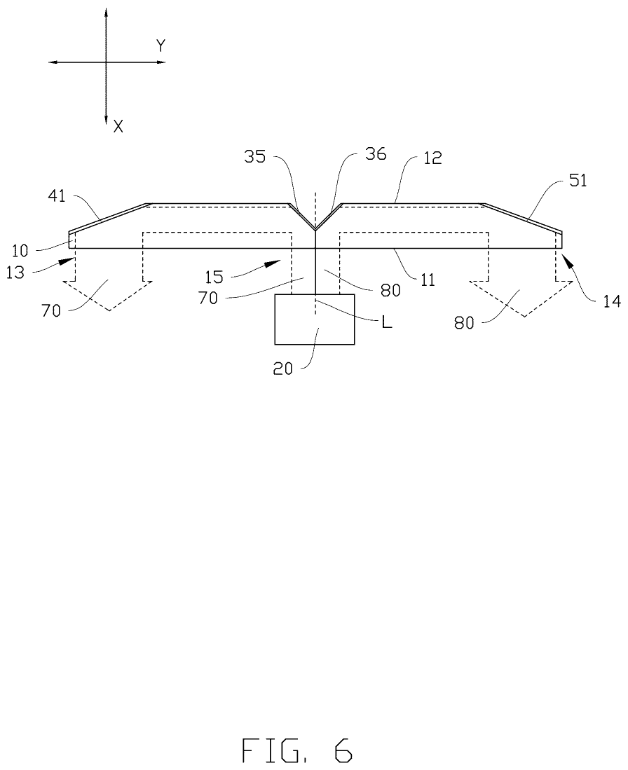

Referring to FIG. 3, FIG. 4 and FIG. 6, in one embodiment, the image light 60 emitted by the display 20 further includes a second image light 80, the first image light 70 is parallel to the second image light 80, one propagation path of first image light 70 is adjacent to other propagation path of the second image light 80. The optical splitter assembly 30 is configured to split the second image light 80 into a third light beam 81 and a fourth light beam 82. The optical splitter assembly 30 further includes a light absorbing portion 32, the light absorbing portion 32 is located inside of the optical waveguide 10, the light absorbing portion 32 is configured to absorb the second light beam 72 and the third light beam 81, and the first light beam 71 is transmitted to the first coupling-out member 40, and the fourth light beam 82 is transmitted to the second coupling-out member 50.

In embodiments of the present application, the first image light 70 and the second image light 80 can be propagated to display different image at each eye of the user independently. In addition, when one of the first image light 70 and the second image light 80 is shifted, it is possible to correct only the shifted image light, and reduces maintenance costs.

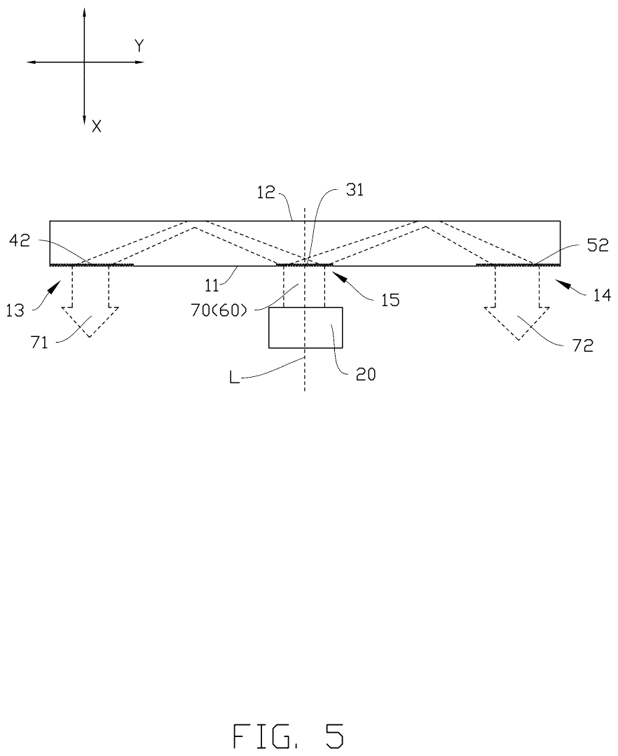

In one embodiment, referring to FIG. 4 and FIG. 5, the first coupling-out member 40 includes a first diffraction grating 42, the first diffraction grating 42 is configured to refract the first light beam 71, and the first light beam 71 is transmitted in the optical waveguide 10 to the first emergent area 13 and emitted out from the first emergent area 13. The first diffraction grating 42 is located on one side of the first surface 11 of the optical waveguide 10, so that the first light beam 71 is emitted from the first exit area 13 directly.

In one embodiment, the first diffraction grating 42 may be provided as a surface relief grating, the surface relief grating has a thin thickness that reduces the effect of transmission of real-world light, conducive to the design of controlling the dispersion problem of the near-eye display device 100 and improve the display effect of the near-eye display device 100. The surface relief gratings can be combined with lens more conveniently, expanding range of application of the near-eye display device 100.

In one embodiment, the first diffraction grating 42 may be provided as a volume holographic grating.

In one embodiment, referring to FIG. 4 and FIG. 5, the second coupling-out member 50 includes a second diffraction grating 52, the second diffraction grating 52 is configured to refract the second light beam 72, and the second light beam 72 is transmitted in the optical waveguide 10 to the second emergent area 14 and emitted out from the second emergent area 14. The second diffraction grating 52 is arranged on the first surface 11 of the optical waveguide 10, so that the second light beam 72 is emitted out of the optical waveguide 10 from the second exit area 14 directly.

In one embodiment, the second diffraction grating 52 may be provided as a surface relief grating, the surface relief grating has a thin thickness that reduces the effect of transmission of real-world light, conducive to the design of controlling the dispersion problem of the near-eye display device and improve the display effect of the near-eye display device 100, the surface relief gratings can be combined with lens more conveniently, expanding range of application of the near-eye display device 100.

In one embodiment, the second diffraction grating 52 may be provided as a volume holographic grating.

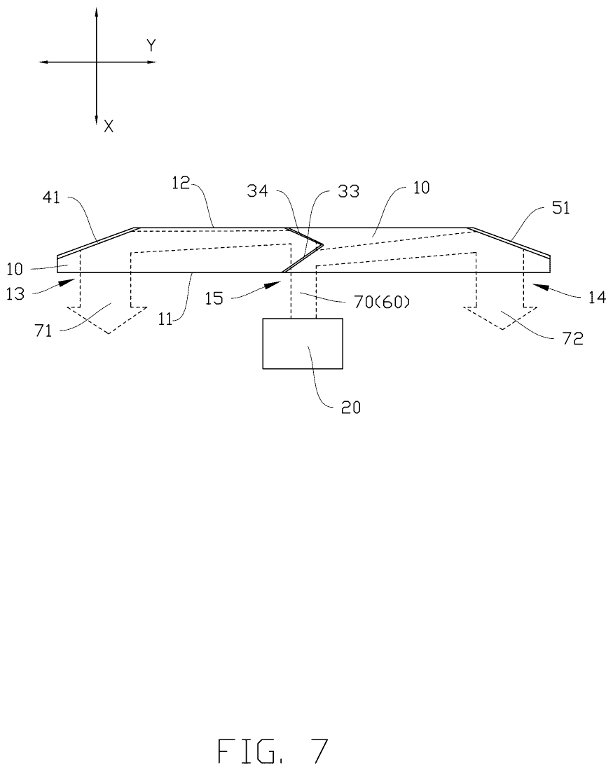

In one embodiment, referring to FIG. 6 and FIG. 7, the first coupling-out member 40 includes a first semi-reflective mirror 41, the first semi-reflective mirror 41 is provided in the optical waveguide 10, and close to the second surface 12, the first semi-reflective mirror 41 is configured to refract the first light beam 71, and the first light beam 71 is transmitted in the optical waveguide 10 to the first emergent area 13 and emitted out from the first emergent area 13.

The first semi-reflective mirror 41 has a lower cost, lower processing difficulty, and higher reliability in use, and can be integrated into optical waveguide 10 simply. Further, the virtual image reflected by the first semi-reflective mirror 41 has less luminance loss, to improve experience of the user.

In one embodiment, referring to FIG. 6 and FIG. 7, the second coupling-out member 50 includes a second semi-reflective mirror 51, the second semi-reflective mirror 51 is disposed on one side of the optical waveguide 10 near the second surface 12, the second semi-reflective mirror 51 is configured to refract the second light beam 72, and the second light beam 72 is transmitted in the optical waveguide 10 to the second emergent area 14 and emitted out from the second emergent area 14.

In one embodiment, referring to FIG. 6 and FIG. 7, the first semi-reflective mirror 41 and the second semi-reflective mirror 51 are axisymmetric about a center line L of the optical waveguide 10 in the second direction Y.

The first semi-reflective mirror 41 has advantages of a lower cost, lower processing difficulty, and higher reliability in use, and can be integrated into optical waveguide 10 simply. Further, the virtual image reflected by the first semi-reflective mirror 41 has less luminance loss, to improve experience of the user.

In one embodiment, referring to FIG. 6, the optical splitter assembly 30 includes a second reflecting portion 35 and a third reflecting portion 36, the second reflecting portion 35 is adjacent to the third reflecting portion 36 in the second direction Y, the second reflecting portion 35 is configured to refract the first image light 70 to the first coupling-out member 40, and the third reflecting portion 36 is configured to refract the second image light 80 to the second coupling-out member 50.

In this way, beam-splitting action of the beam-splitting assembly 30 on the image light 60 is achieved by the second reflecting portion 35 and the third reflecting portion 36.

In one embodiment, the second reflecting portion 35 may be provided as a reflective mirror, the third reflecting portion 36 may be provided as a reflective mirror. The reflective mirrors are easy to install at the optical waveguide 10, and the reflective mirror has advantages of a low setup cost and a long service life, and angle adjustment of the reflective mirror within the optical waveguide 10 is more convenient, further, the virtual image reflected by the first semi-reflective mirror 41 has less luminance loss.

In one embodiment, referring to FIG. 6, the second reflecting portion 35 and the third reflecting portion 36 are axisymmetric about a center line L of the optical waveguide 10 in the second direction Y.

In one embodiment, referring to FIG. 7, the optical splitter assembly 30 includes a semi-reflective portion 33 and a first reflecting portion 34, the semi-reflective portion 33 is spaced apart from the first reflecting portion 34 in the first direction X, the semi-reflective portion 33 is arranged between the first reflecting portion 34 and the display 20 along the first direction X, the semi-reflective portion 33 is arranged near the first surface 11, and the first reflective portion 34 is provided close to the second surface 12. The semi-reflective portion 33 is configured to divide the first image light 70 into the first light beam 71 and the second light beam 72, and reflect the second light beam 72 to the second coupling-out member 50, and the first light beam 71 is directed towards the first reflecting portion 34. The first reflecting portion 34 is configured to reflect the first light beam 71 to the first coupling-out member 40.

In one embodiment, the semi-reflective portion 33 may be provided as a half-reflecting mirror, the first reflecting portion 34 may be provided as a reflective mirror, the half-reflecting mirror and the reflective mirror has advantages of a lower cost, lower processing difficulty, and higher reliability in use, and can be integrated into optical waveguide 10 simply. Further, the virtual image reflected by the first semi-reflective mirror 41 has less luminance loss, to improve experience of the user.

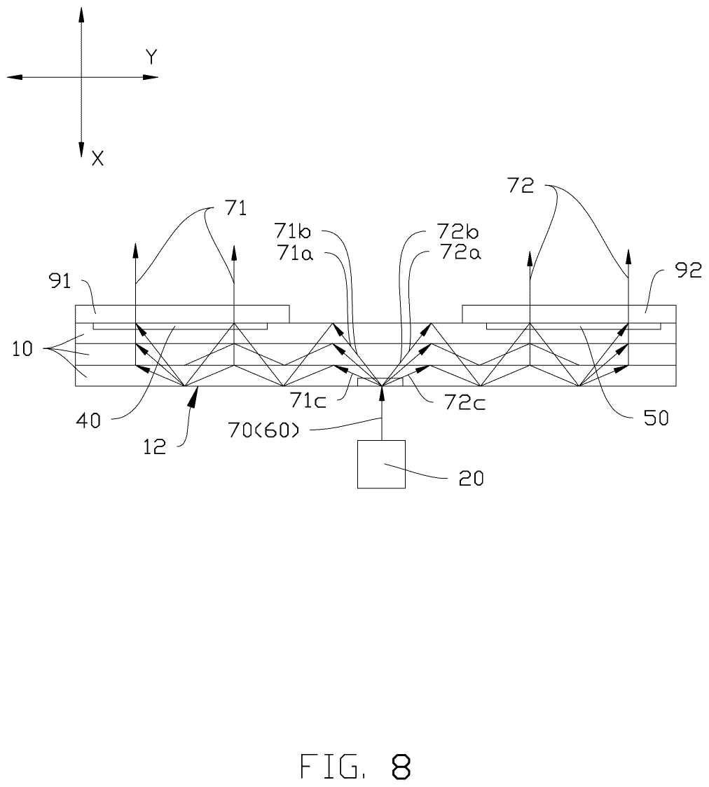

In one embodiment, referring to FIG. 8, the near-eye display device 100 further includes a plurality of optical waveguides 10, the plurality of optical waveguides 10 is arranged one on top of another in the first direction X, and the second surface 12 of each of the plurality of optical waveguides 10 is a fully reflective surface, and a range of wavelengths of light reflected by the second surface 12 of each of the plurality of optical waveguides 10 is different from each other.

Light of different wavelength ranges may be reflected in different optical waveguides 10 respectively, so that light of different wavelength ranges can all be emitted from the same position in the first emergent area 13 or the second emergent area 14, and at the emission position, distribution ratio of the light in different wavelength ranges is similar or the same, thereby improving color uniformity of the light emitted from the first emergent area 13 or the second emergent area 14, reducing rainbow effect, and improving the user experience.

What is claimed is:

1. A near-eye display device, comprising:
one or more optical waveguide, the optical waveguide defines a first surface and a second surface, wherein the first surface and the second surface are arranged on opposite sides of the near-eye display device, the first surface is opposite to the second surface in a first direction; the first surface defines a first emergent area and a second emergent area, the first emergent area is spaced apart from the second emergent area in a second direction, the first direction intersects with the second direction;
a display provided at one side of the optical waveguide, and configured to emit an image light into the optical waveguide, the emitted image light comprising a first image light, and a projection of the display on the first surface of the optical waveguide being between the first emergent area and the second emergent area;
an optical splitter assembly, a first coupling-out member and a second coupling-out member, wherein the optical splitter assembly is provided on the optical waveguide, the optical splitter assembly is configured to split the first image light into a first light beam and a second light beam, the first light beam propagates within the optical waveguide to the first coupling-out member, and the first coupling-out member is configured to couple the first light beam out of the optical waveguide, the second light beam propagates within the optical waveguide to the second coupling-out member, and the second coupling-out member is configured to couple the second light beam out of the optical waveguide.

2. The near-eye display device as claimed in claim 1, wherein the optical splitter assembly comprises an optical splitter grating, the optical splitter grating is configured to split the first image light into the first light beam and the second light beam, and couple the first light beam into the optical waveguide on one side of the optical splitter grating along the second direction, and couple the second light beam into the optical waveguide on another side of the optical splitter grating along the second direction.

3. The near-eye display device as claimed in claim 2, wherein the image light emitted by the display further comprises a second image light, the first image light is parallel to the second image light, a propagation path of first image light is adjacent to a propagation path of the second image light, and the optical splitter assembly is configured to split the second image light into a third light beam and a fourth light beam;
the optical splitter assembly further comprises a light absorbing portion, the light absorbing portion is located inside of the optical waveguide, the light absorbing portion is configured to absorb the second light beam and the third light beam, and the first light beam is transmitted to the first coupling-out member, the fourth light beam is transmitted to the second coupling-out member.

4. The near-eye display device as claimed in claim 1, wherein the optical splitter assembly comprises a semi-reflective portion and a first reflecting portion, the semi-reflective portion is spaced apart from the first reflecting portion in the first direction, the semi-reflective portion is located between the first reflecting portion and the display along the first direction;
the semi-reflective portion is configured to divide the first image light into the first light beam and the second light beam, and reflect the second light beam to the second coupling-out member, and the first light beam is directed towards the first reflecting portion, and the first reflecting portion is configured to reflect the first light beam to the first coupling-out member.

5. The near-eye display device as claimed in claim 1, wherein the image light emitted by the display further comprises a second image light, the first image light is parallel to the second image light, a propagation path of first image light is adjacent to a propagation path of the second image light;
the optical splitter assembly comprises a second reflecting portion and a third reflecting portion, the second reflecting portion is adjacent to the third reflecting portion in the second direction, the second reflecting portion is configured to refract the first image light to the first coupling-out member, and the third reflecting portion is configured to refract the second image light to the second coupling-out member.

6. The near-eye display device as claimed in claim 5, wherein the second reflecting portion and the third reflecting portion are axisymmetric about a center line of the optical waveguide in the second direction.

7. The near-eye display device as claimed in claim 1, wherein the first coupling-out member comprises a first semi-reflective mirror, the first semi-reflective mirror is disposed on one side of the optical waveguide near the second surface, the first semi-reflective mirror is configured to refract the first light beam, and the first light beam is transmitted in the optical waveguide to the first emergent area and emitted out from the first emergent area.

8. The near-eye display device as claimed in claim 1, wherein the first coupling-out member comprises a first diffraction grating, the first diffraction grating is configured to refract the first light beam, and the first light beam is transmitted in the optical waveguide to the first emergent area and emitted out from the first emergent area.

9. The near-eye display device as claimed in claim 8, wherein the first diffraction grating is a surface relief grating or a volume holographic grating.

10. The near-eye display device as claimed in claim 1, wherein the second coupling-out member comprises a second semi-reflective mirror, the second semi-reflective mirror is disposed on one side of the optical waveguide near the second surface, the second semi-reflective mirror is configured to refract the second light beam, and the second light beam is transmitted in the optical waveguide to the second emergent area and emitted out from the second emergent area.

11. The near-eye display device as claimed in claim 1, wherein the first coupling-out member comprises a first semi-reflective mirror, the first semi-reflective mirror is disposed on one side of the optical waveguide near the second surface, the first semi-reflective mirror is configured to refract the first light beam, and the first light beam is transmitted in the optical waveguide to the first emergent area and emitted out from the first emergent area; the second coupling-out member comprises a second semi-reflective mirror, the second semi-reflective mirror is disposed on one side of the optical waveguide near the second surface, the second semi-reflective mirror is configured to refract the second light beam, and the second light beam is emitted from the second emergent area; the first semi-reflective mirror and the second semi-reflective mirror are axisymmetric about a center line of the optical waveguide in the second direction.

12. The near-eye display device as claimed in claim 1, wherein the second coupling-out member comprises a second diffraction grating, the second diffraction grating is configured to refract the second light beam, and the second light beam is transmitted in the optical waveguide to the second emergent area and emitted out from the second emergent area.

13. The near-eye display device as claimed in claim 12, wherein the second diffraction grating is a surface relief grating or a volume holographic grating.

14. The near-eye display device as claimed in claim 1, wherein the first coupling-out member comprises a first diffraction grating, the first diffraction grating is configured to refract the first light beam, and the first light beam is emitted from the first emergent area; the second coupling-out member comprises a second diffraction grating, the second diffraction grating is configured to refract the second light beam, and the second light beam is transmitted in the optical waveguide to the second emergent area and emitted out from the second emergent area; and the first diffraction grating and the second diffraction grating are axisymmetric about a center line of the optical waveguide in the second direction.

15. The near-eye display device as claimed in claim 1, further comprising a plurality of optical waveguides, the plurality of optical waveguides is arranged one on top of another in the first direction, and a second surface of each of the plurality of optical waveguides is a fully reflective surface, and a range of wavelengths of light reflected by the second surface of each of the plurality of optical waveguides is different from each other.

16. The near-eye display device as claimed in claim 1, wherein the one or more optical waveguide is a monolithic substrate structure.

17. The near-eye display device as claimed in claim 16, further comprising a first wave plate and a second wave plate, the first wave plate is arranged on the first emergent area, the second wave plate is arranged on the second emergent area.
